(19) United States
(12) Patent Application Publication
(10) Pub. No.: US 2022/0400427 A1
(43) Pub. Date: Dec. 15, 2022

(54) METHODS AND SYSTEMS FOR TRANSMITTING INTEGRATED ACCESS AND BACKHAUL INFORMATION

(71) Applicant: ZTE Corporation, Shenzhen (CN)

(72) Inventors: Ying Huang, Shenzhen (CN); Lin Chen, Shenzhen (CN)

(21) Appl. No.: 17/889,591

(22) Filed: Aug. 17, 2022

Related U.S. Application Data
(63) Continuation of application No. PCT/CN2020/075564, filed on Feb. 17, 2020.

(51) Int. Cl. H04W 48/08; H04W 48/16; H04W 8/02

(52) U.S. Cl. CPC H04W 48/08; H04W 48/16; H04W 8/02

(57) ABSTRACT

Methods, apparatus, and systems for reducing signalling in a wireless system, where one or more user equipment or mobile terminals are connected to an integrated access and backhaul node. The disclosure relates to providing integrated access and backhaul indication information that includes at least a mobile integrated access and backhaul node indication information or a group mobility indication. The integrated access and backhaul indication information could be used to reduce signaling overhead and ensure service continuity.

### CROSS REFERENCE TO RELATED APPLICATIONS

This patent document is a continuation of and claims benefit of priority to International Patent Application No. PCT/CN2020/075564, filed on Feb. 17, 2020. The entire content of the before-mentioned patent application is incorporated by reference as part of the disclosure of this application.

### TECHNICAL FIELD

This disclosure is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for communicating in an integrated access and backhaul (IAB) deployment for New Radio (NR). IAB indication information that is usable for an IAB deployment.

The following aspects may be preferably implemented in various embodiments. In one aspect, IAB indication information includes mobile IAB information that is usable in an IAB deployment. In one aspect, the has one or more MT or UE connected to it.

In another aspect, the IAB indication information is transmitted to a base station, and the mobile IAB node information indicates that the IAB node is a mobile IAB node. In another aspect, the mobile IAB node information is usable to select a network element that supports mobile IAB to serve the MT or UE after the mobile IAB indication is received.

In another aspect, the IAB indication information is transmitted by the IAB node or by the MT or UE via a radio resource control (RRC) message. In another aspect, the IAB indication information is transmitted via an RRC setup complete message, or measurement report message, or UE Assistance Information message.

In another aspect, the IAB indication information is transmitted by the IAB node in system information and the IAB node information indicates that the IAB node is a mobile IAB node or that the IAB node supports mobile integrated access and backhaul.

In another aspect, the IAB indication information is transmitted from one base station to another via an Xn Application Protocol (XnAP) message and the mobile IAB node information indicates that the base station supports the mobile IAB node.

In yet another aspect, the base station is an IAB donor central unit (CU) or integrated access and backhaul donor gNB. In yet another aspect, the IAB indication information is sent via an XN SETUP REQUEST, or XN SETUP RESPONSE, or NG-RAN NODE CONFIGURATION UPDATE, or NG-RAN NODE CONFIGURATION UPDATE ACKNOWLEDGE message.

In another aspect, the IAB indication information is transmitted via an NG Application Protocol (NGAP) message from a base station to an Access Mobility Management Function (AMF) or from the AMF to the base station and the mobile IAB node information indicates that the base station or AMF supports mobile IAB.

In yet another aspect, the base station is an IAB donor central unit (CU) or integrated access and backhaul donor gNB. In yet another aspect, the IAB indication information is transmitted via an NG SETUP REQUEST, or NG SETUP RESPONSE, or RAN CONFIGURATION UPDATE, or RAN CONFIGURATION UPDATE ACKNOWLEDGE, or AMF CONFIGURATION UPDATE, or AMF CONFIGURATION UPDATE ACKNOWLEDGE.

In another aspect, IAB indication information comprises group mobility information, the IAB indication information is usable when an IAB node that has one or more MT or UE connected to it. In another aspect, the IAB indication information is transmitted from the IAB node or from the MT or UE via a radio resource control (RRC) message the group mobility indication indicates that the MT or UE supports or that the MT or UE intends to perform group mobility, and the group mobility indication is usable by a base station to initiate handover of the devices connected to the IAB node.

In yet another aspect, the IAB information is transmitted via an RRC setup complete message, measurement report message, or UE Assistance Information message.

In another aspect, the IAB indication information is transmitted by the IAB node in system information, the group mobility indication indicates that the IAB node supports group mobility.

In another aspect, the IAB indication information is transmitted from one base station to another via an Xn Application Protocol (XnAP) message and the group mobility indication indicates that the base station supports group mobility.

In another aspect, the base station is an IAB donor central unit (CU) or IAB donor gNB. In yet another aspect, the IAB indication information is sent via an XN SETUP REQUEST, or XN SETUP RESPONSE, or NG-RAN NODE CONFIGURATION UPDATE, or NG-RAN NODE CONFIGURATION UPDATE ACKNOWLEDGE message. In another aspect, IAB indication information is transmitted via an NG Application Protocol (NGAP) message from a base station to an Access Mobility Management Function (AMF) or from the AMF to the base station and the group mobility indication indicates that the base station or AMF supports group mobility.

In yet another aspect, the base station is an IAB donor central unit (CU) or integrated access and backhaul donor gNB. In yet another aspect, the IAB indication information is sent via an NG SETUP REQUEST, or NG SETUP RESPONSE, or RAN CONFIGURATION UPDATE, or RAN CONFIGURATION UPDATE ACKNOWLEDGE, or AMF CONFIGURATION UPDATE, or AMF CONFIGURATION UPDATE ACKNOWLEDGE.

In aspects of the disclosure, the transmission and reception of messages is performed by various devices, including MT, UE, IAB nodes, and IAB donors.

These, and other, aspects are described in the present disclosure.

### BRIEF DESCRIPTION OF DRAWINGS

FIG. 1 illustrates an embodiment of an IAB deployment in a moveable vehicle.

FIG. 2 illustrates an embodiment of an IAB topology.

FIG. 3 illustrates an embodiment of an IAB indication information transmitted in an RRC message.

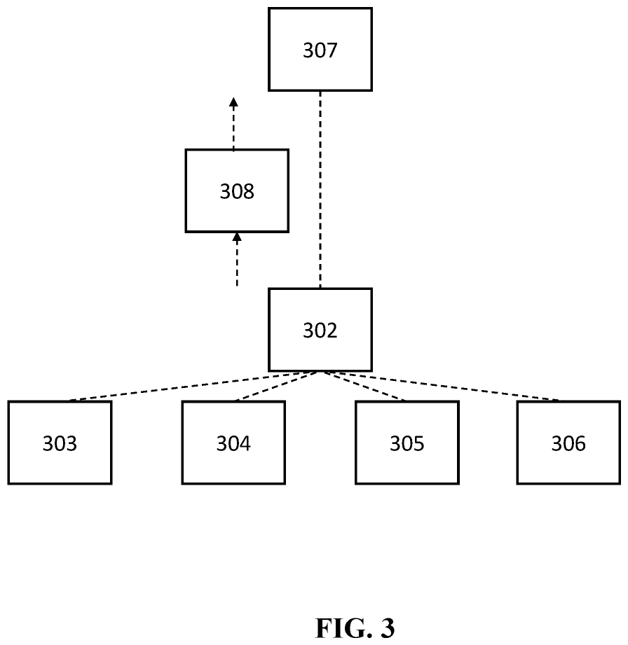

FIG. 4 illustrates an embodiment of IAB indication information in system information.

FIG. 5 illustrates an IAB donor transmitting to another IAB donor IAB indication information via an XnAP message.

FIG. 6 illustrates IAB indication information being transmitted via an NGAP message.

FIG. 7 is a flowchart illustrating a MT transmitting IAB indication information via an RRC message.

FIG. 8 is a flowchart illustrating an IAB node transmitting an IAB indication information via an RRC message.

FIG. 9 is a flowchart illustrating an IAB donor transmitting an IAB indication information via an XnAP message.

FIG. 10 is a flowchart illustrating an IAB donor transmitting an IAB indication information via an NGAP message.

FIG. 11 is a flowchart illustrating an AM transmitting an IAB indication information via an NGAP message.

FIG. 12 shows an example of a wireless communication system where techniques in accordance with one or more embodiments of the present technology can be applied.

FIG. 13 is a block diagram representation of a portion of a radio station in accordance with one or more embodiments of the present technology can be applied.

### DETAILED DESCRIPTION

The disclosure relates to wireless systems. More specifically, it relates to transmitting and receiving identifying information that the network can use. As an example, the identifying information can be used in handover, or in selecting network elements, or in identifying a device as supporting mobile IAB.

For instance, an integrated access and backhaul (IAB) system supports wireless backhauling by deploying new radio (NR) cells to reduce the need for wireline transport infrastructure.

The terminating node of the NR backhaul network on the network side is commonly referred to as an IAB donor, which represents a gNB, which is the logical node that has additional functionality to support IAB. An IAB node supports gNB Distributed Unit (gNB-DU) functionality, which allows NR access to user equipment (UE) and next-hop IAB nodes. The IAB node also supports functionality for IAB-MT, which allows connections to the gNB-DU of another IAB node or the IAB donor.

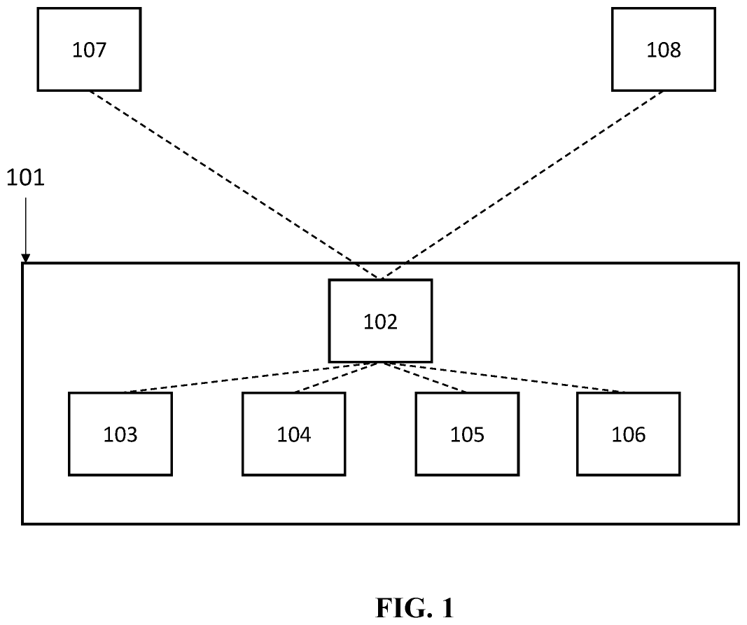

In one example, as shown in FIG. 1, a moveable vehicle, such as a high speed train 101 has several passengers with one or more mobile terminal (MT) or user equipment (UE) 103-106. The UE 103-106 are wirelessly connected to an IAB node 102, and the IAB node 102 is in turn connected to a donor node or a parent IAB node 107 or 108. As the high speed train moves, handover between parent IAB nodes occurs. The UE 103-106 accesses the network via the IAB node 102, and the IAB node 102 accesses the network via a parent IAB node. Here, it should be understood that the usage of UE and MT are not mutually exclusive, and one should presume that either term can refer to either a MT or UE. It should also be understood that a parent IAB node should be understood to be encompassed by the term base station.

The relative positions between the UEs 103-106 and the IAB node 102 will change little as the train 101 travels across. However, the relative position between the IAB node 102 and each IAB donor will change frequently when the train 101 travels.

Consequently, this disclosure provides systems and methods for reducing signaling. In an embodiment, handover of the IAB node 102 can be performed, as opposed to handover of every single UE 103-106. This reduces signaling overhead and improves service continuity.

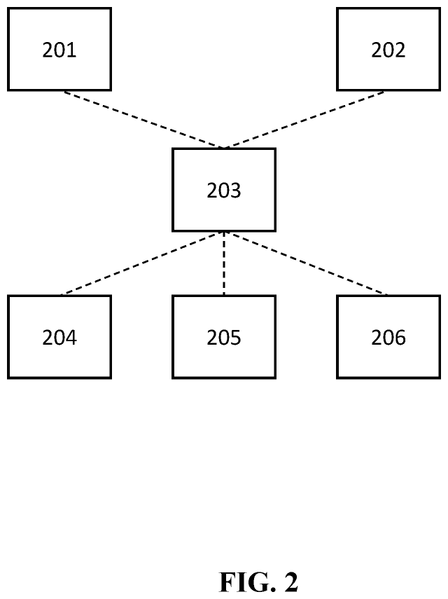

FIG. 2 illustrates an IAB topology. Parent nodes 201 and 202 have IAB-DU functionality, and they provide NR access to an IAB node 203. IAB node 203 has functionality as both an IAB MT and as an IAB DU. IAB node 203 can connect to parent nodes 201 and 202 as a IAB MT, and also provide access to child nodes 204-206 as a IAB DU. Child nodes 204-206 have functionality of an IAB MT. As can be understood, any node in the topology can work as a donor or a terminal, so long as it is designed with that functionality.

In an embodiment one or more UEs 303-306 are connected to an IAB node 302 that sends IAB indication information 308 to an IAB donor central unit (CU) 307 via a Radio Resource Control (RRC) message. In another embodiment, a UE 303 sends IAB indication information 308 to the IAB donor CU 307 via an RRC message.

The IAB indication information can have at least mobile IAB node indication information and/or group mobility indication. In an embodiment, the IAB indication information has mobile IAB node indication information, the mobile IAB node indication information indicates that the IAB node 302 is a mobile IAB node. The network would then know that the IAB node 302 is in a scenario similar to that as depicted in FIG. 1, and in an embodiment handover of the group can be conducted accordingly.

In another embodiment, the IAB indication information includes a group mobility indication. The group mobility indication indicates that the UEs 303-306 supports group mobility or that the UE intends to perform group mobility. In an embodiment, the IAB donor CU 307 initiates a group mobility procedure in the handover scenario after receiving the group mobility indication.

In an embodiment, the IAB indication information sent via the RRC message can be sent via an RRC setup complete message or a measurement report message or an UE Assistance Information message.

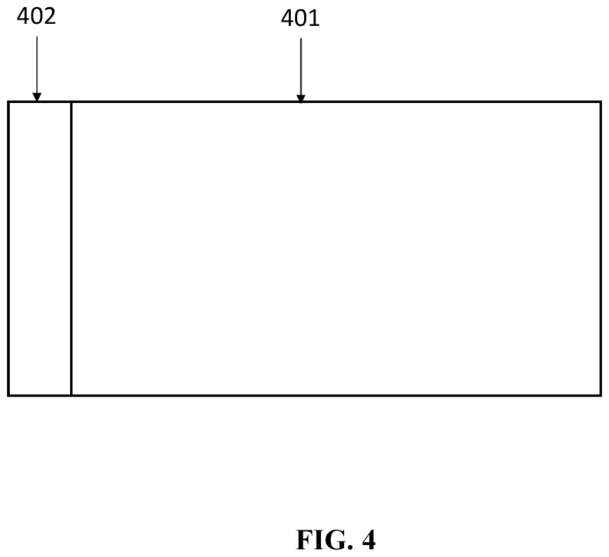

In another embodiment, as shown in FIG. 4, an IAB node includes IAB indication information 402 in its system information 401. The IAB indication information 402 includes at least one of mobile IAB node indication that indicates that the IAB node is a mobile IAB node (or that the IAB node supports mobile IAB node) or group mobility indication, which indicates that the IAB node supports group mobility.

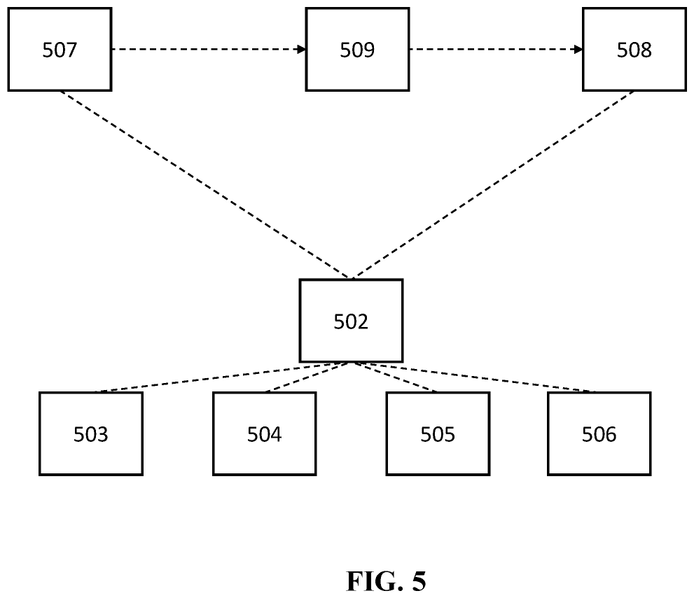

In yet another embodiment, the Xn Application Protocol (XnAP) is used to transmit IAB indication information. As shown in FIG. 5, a series of UEs 503-506 are connected to an IAB node 502. The IAB node 502 is connected to one or more IAB donors 507/508, and one IAB donor 507 transmits to another IAB donor 508 an XnAP message 509 that includes an IAB indication information.

The IAB indication information includes at least one of a mobile IAB node indication or a group mobility indication. The mobile IAB node indication indicates that the IAB donor supports mobile IAB node. The group mobility indication indicates that the IAB donor supports group mobility.

Although FIG. 5 depicts IAB donor 507 and IAB donor 508 connected to an IAB node 502, it should be understood that any number of IAB donors (or no IAB donors) need be connected to the IAB node when the IAB indication information is transmitted in the XnAP message 509.

In an embodiment, the IAB donor is an IAB donor CU or an IAB donor gNB. In another embodiment, the IAB indication information could be sent via a XN SETUP REQUEST or XN SETUP RESPONSE or NG-RAN NODE CONFIGURATION UPDATE or NG-RAN NODE CONFIGURATION UPDATE ACKNOWLEDGE message.

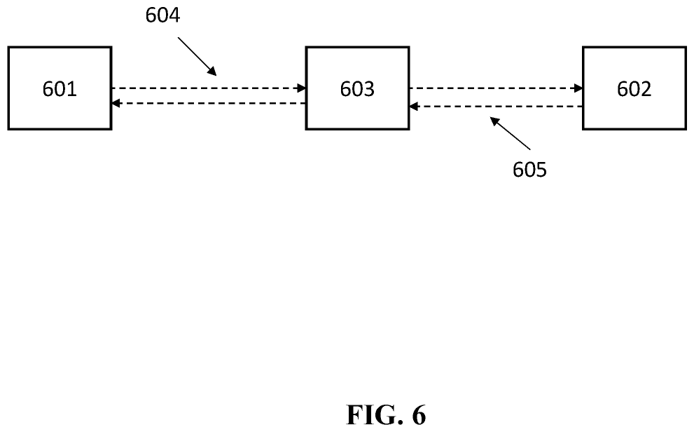

In an embodiment, as shown in FIG. 6, an IAB donor 601 transmits IAB indication information in an NG Application Protocol (NGAP) message 603 to an Access and Mobility Management Function (AMF) 602, which can be located on any device. Annotation 604 illustrates that the NGAP message 603 is transmitted from the IAB donor 601 to the AMF 602.

In another embodiment, the AMF 602 transmits the IAB indication information in an NGAP message 603 to an IAB donor 601. The annotation 605 indicates that the NGP message 603 is transmitted from the AMF 602.

The IAB indication information in the NGAP message 603 has at least one of a mobile IAB node indication or a group mobility indication. The mobile IAB node indication information indicates that the IAB donor or the AMF supports mobile IAB node. The group mobility indication indicates that the IAB donor or AM supports group mobility.

In an embodiment, the IAB donor is IAB donor CU and/or IAB donor gNB. The IAB indication information can be sent via a NG SETUP REQUEST or NG SETUP RESPONSE, RAN CONFIGURATION UPDATE or RAN CONFIGURATION UPDATE ACKNOWLEDGE or AMF CONFIGURATION UPDATE or AMF CONFIGURATION UPDATE ACKNOWLEDGE

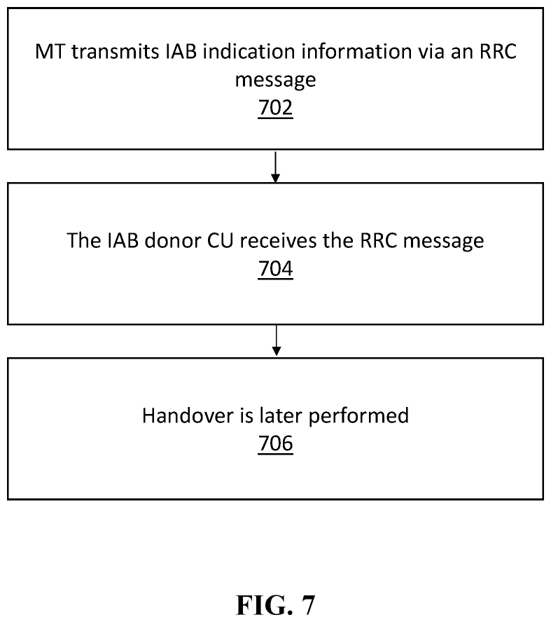

As shown in the follow chart of FIG. 7, in an embodiment a MT transmits IAB indication information via an RRC message 702. The IAB indication information has at least one of mobile IAB node indication information or group mobility information. The IAB indication information can be sent via an RRC setup complete message or a measurement report message or a UE Assistance information. The IAB donor CU receives the RRC message 704. In an embodiment, handover is later performed 706. It should be understood that the MT described could be an UE.

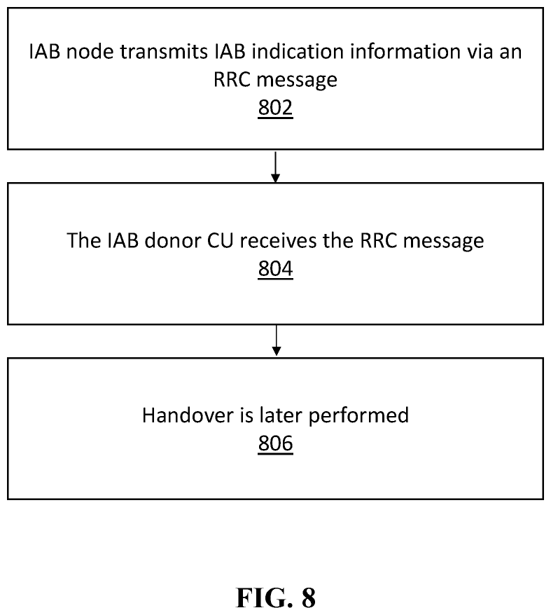

As shown in the follow chart of FIG. 8, in an embodiment an IAB node transmits IAB indication information via an RRC message 802. The IAB indication information has at least one of mobile IAB node indication information or group mobility information. The IAB indication information can be sent via an RRC setup complete message or a measurement report message or a UE Assistance information. The IAB donor CU receives the RRC message 804. In an embodiment, handover is later performed 806.

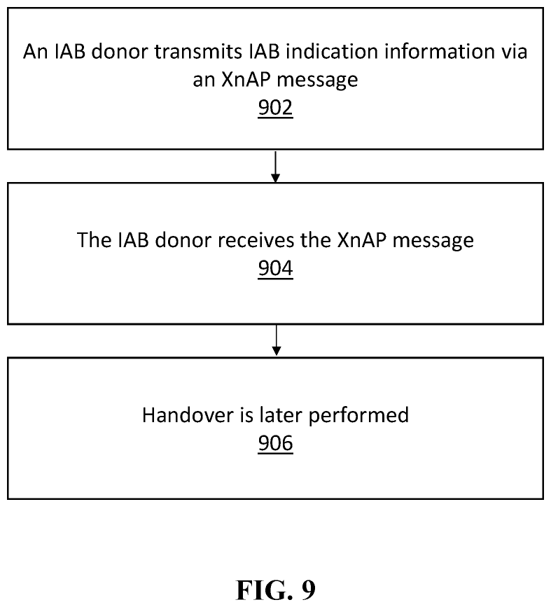

As shown in the follow chart of FIG. 9, in an embodiment an IAB donor transmits IAB indication information to another IAB donor via an XnAP message. The IAB indication information has at least one of mobile IAB node indication information or group mobility information. The IAB donor can be an IAB donor CU or IAB donor gNB, and the IAB indication information can be sent via a XN SETUP REQUEST, or XN SETUP RESPONSE, or NG-RAN NODE CONFIGURATION UPDATE, or NG-RAN NODE CONFIGURATION UPDATE ACKNOWLEDGE message. The XnAP message is received at the IAB donor 904. In an embodiment, handover is later performed 906.

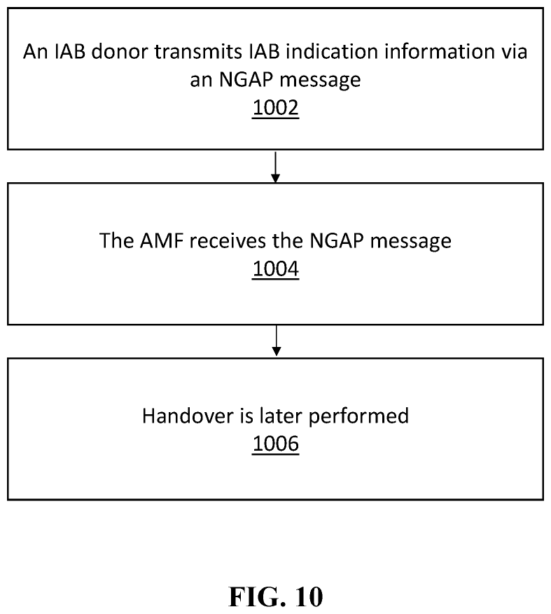

As shown in the flowchart of FIG. 10, in an embodiment an IAB donor sends IAB indication information via an NGAP message 1002. The IAB indication information has at least one of mobile IAB node indication information or group mobility information. The AMF receives the NGAP message 1004. In an embodiment, handover is later performed 1006. The IAB indication information has at least one of mobile IAB node indication information or group mobility information. Further, the IAB donor can be an IAB donor CU or an IAB donor gNB. The IAB indication information can be sent via an NG SETUP REQUEST, or NG SETUP RESPONSE, or RAN CONFIGURATION UPDATE, or RAN CONFIGURATION UPDATE ACKNOWLEDGE, or AMF CONFIGURATION UPDATE, or AMF CONFIGURATION UPDATE ACKNOWLEDGE.

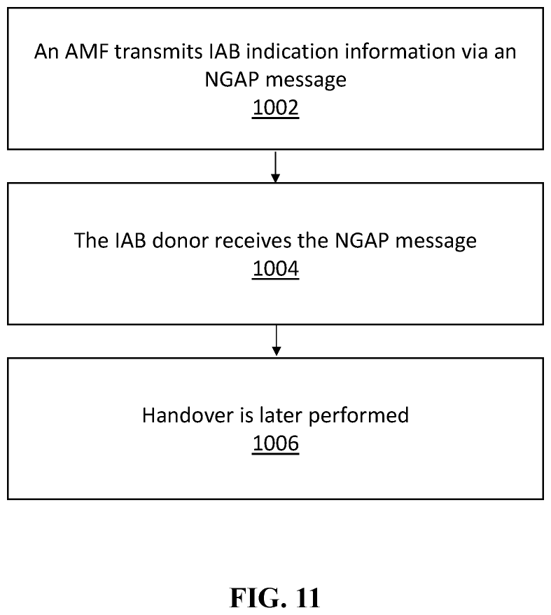

As shown in the flowchart of FIG. 11, in an embodiment an AMF sends IAB indication information via an NGAP message 1002. The IAB indication information has at least one of mobile IAB node indication information or group mobility information. The IAB donor receives the NGAP message 1004. In an embodiment, handover is later performed 1006. The IAB indication information has at least one of mobile IAB node indication information or group mobility information. Further, the IAB donor can be an IAB donor CU or an IAB donor gNB. The IAB indication information can be sent via an NG SETUP REQUEST, or NG SETUP RESPONSE, or RAN CONFIGURATION UPDATE, or RAN CONFIGURATION UPDATE ACKNOWLEDGE, or AMF CONFIGURATION UPDATE, or AMF CONFIGURATION UPDATE ACKNOWLEDGE.

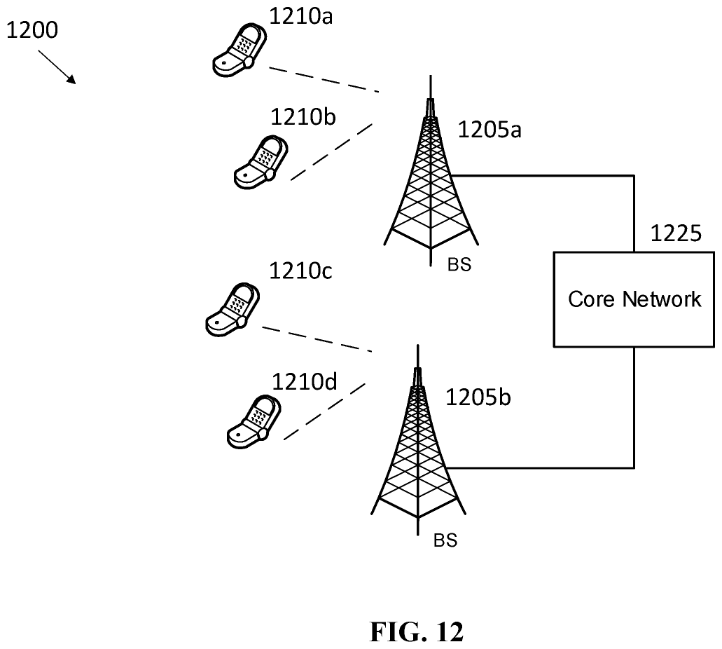

FIG. 12 shows an example of a wireless communication system 1200 where techniques in accordance with one or more embodiments of the present technology can be applied. A wireless communication system 1200 can include one or more base stations (BSs) 1205a, 1205b, one or more wireless devices 1210a, 1210b, 1210c, 1210d, and a core network 1225. A base station 1205a, 1205b can provide wireless service to wireless devices 1210a, 1210b, 1210c and 1210d in one or more wireless sectors. In some implementations, a base station 1205a, 1205b includes directional antennas to produce two or more directional beams to provide wireless coverage in different sectors. As should be understood, with reference to FIGS. 1 and 2, the base stations can be a series of IAB nodes.

The core network 1225 can communicate with one or more base stations 1205a, 1205b. The core network 1225 provides connectivity with other wireless communication systems and wired communication systems. The core network may include one or more service subscription databases to store information related to the subscribed wireless devices 1210a, 1210b, 1210c, and 1210d. A first base station 1205a can provide wireless service based on a first radio access technology, whereas a second base station 1205b can provide wireless service based on a second radio access technology. The base stations 1205a and 1205b may be co-located or may be separately installed in the field according to the deployment scenario. The wireless devices 1210a, 1210b, 1210c, and 1210d can support multiple different radio access technologies. The techniques and embodiments described in the present document may be implemented by the base stations of wireless devices described in the present document.

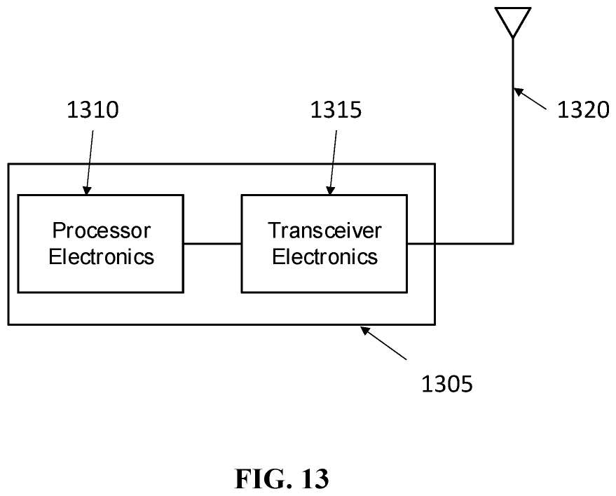

FIG. 13 is a block diagram representation of a portion of a radio station in accordance with one or more embodiments of the present technology can be applied. A radio station 1305 such as a base station or a wireless device (or UE) or MT can include processor electronics 1310 such as a microprocessor that implements one or more of the wireless techniques presented in this document. The radio station 1305 can include transceiver electronics 1315 to send and/or receive wireless signals over one or more communication interfaces such as antenna 1320. The radio station 1305 can include other communication interfaces for transmitting and receiving data. Radio station 1305 can include one or more memories (not explicitly shown) configured to store information such as data and/or instructions. In some implementations, the processor electronics 1310 can include at least a portion of the transceiver electronics 1315. In some embodiments, at least some of the disclosed techniques, modules or functions are implemented using the radio station 1305. In some embodiments, the radio station 1305 may be configured to perform the methods described herein.

It will be appreciated that the present document discloses techniques that can be embodied in various embodiments of IAB deployments. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. An information transmission method comprising:
transmitting integrated access and backhaul indication information, the integrated access and backhaul indication information comprising mobile integrated access and backhaul node information, the integrated access and backhaul indication information being usable when a mobile integrated access and backhaul node has one or more User Equipment (UE) connected to it.

2. The information transmission method of claim 1, wherein:
the integrated access and backhaul indication information is transmitted to a base station; and
the mobile integrated access and backhaul node information indicates that the integrated access and backhaul node is a mobile integrated access and backhaul node.

3. The information transmission method of claim 2, wherein the integrated access and backhaul indication information is transmitted by the integrated access and backhaul node or by the UE via a radio resource control (RRC) message.

4. The information transmission method of claim 3, wherein the integrated access and backhaul information is transmitted via an RRC setup complete message, or measurement report message, or UE Assistance Information message.

5. The information transmission method of claim 1, wherein:
the integrated access and backhaul indication information is transmitted by the integrated access and backhaul node in system information; and
the mobile integrated access and backhaul node information indicates that the integrated access and backhaul node is a mobile integrated access and backhaul node or that the integrated access and backhaul node supports mobile integrated access and backhaul.

6. The information transmission method of claim 1, wherein:
the integrated access and backhaul indication information is transmitted from one base station to another via an Xn Application Protocol (XnAP) message,
wherein the base stations are integrated access and backhaul donor central unit (CU) or integrated access and backhaul donor gNB; and
the mobile integrated access and backhaul node information indicates that the base station supports the mobile integrated access and backhaul node,
wherein the integrated access and backhaul indication information is sent via an XN SETUP REQUEST, or XN SETUP RESPONSE, or NG-RAN NODE CONFIGURATION UPDATE, or NG-RAN NODE CONFIGURATION UPDATE ACKNOWLEDGE message.

7. The information transmission method of claim 1, wherein:
the integrated access and backhaul indication information is transmitted via an NG Application Protocol (NGAP) message from a base station to an Access Mobility Management Function (AMF) or from the AMF to the base station; and
the mobile integrated access and backhaul node information indicates that the base station or AMF supports mobile integrated access and backhaul.

8. The information transmission method of claim 7, wherein the base station is an integrated access and backhaul donor central unit (CU) or integrated access and backhaul donor gNB.

9. The information transmission method of claim 7, wherein the integrated access and backhaul indication information is transmitted via an NG SETUP REQUEST, or NG SETUP RESPONSE, or RAN CONFIGURATION UPDATE, or RAN CONFIGURATION UPDATE ACKNOWLEDGE, or AMF CONFIGURATION UPDATE, or AMF CONFIGURATION UPDATE ACKNOWLEDGE.

10. An information transmission method comprising:
transmitting integrated access and backhaul indication information, the integrated access and backhaul indication information comprising a group mobility indication; and
the integrated access and backhaul indication information being usable when a mobile integrated access and backhaul node has one or more User Equipment (UE) connected to it.

11. The information transmission method of claim 10, wherein:
the integrated access and backhaul indication information is transmitted from the integrated access and backhaul node or from the UE via a radio resource control (RRC) message; and
the group mobility indication indicates that the UE supports or that the UE intends to perform group mobility, or indicates that the IAB node supports or that the IAB node intends to perform group mobility.

12. The information transmission method of claim 11, wherein the integrated access and backhaul information is transmitted via an RRC setup complete message, or measurement report message, or UE Assistance Information message.

13. The information transmission method of claim 10, wherein:
the integrated access and backhaul indication information is transmitted by the integrated access and backhaul node in system information; and
the group mobility indication indicates that the integrated access and backhaul node supports group mobility.

14. The information transmission method of claim 10, wherein:
the integrated access and backhaul indication information is transmitted from one base station to another via an Xn Application Protocol (XnAP) message,
wherein the base stations are integrated access and backhaul donor central unit (CU) or integrated access and backhaul donor gNB,
wherein the integrated access and backhaul indication information is sent via an XN SETUP REQUEST, or XN SETUP RESPONSE, or NG-RAN NODE CONFIGURATION UPDATE, or NG-RAN NODE CONFIGURATION UPDATE ACKNOWLEDGE message; and
the group mobility indication indicates that the base station supports group mobility.

15. The information transmission method of claim 10, wherein:
the integrated access and backhaul indication information is transmitted via an NG Application Protocol (NGAP) message from a base station to an Access Mobility Management Function (AMF) or from the AMF to the base station; and
the group mobility indication indicates that the base station or AMF supports group mobility.

16. The information transmission method of claim 15, wherein the base station is an integrated access and backhaul donor central unit (CU) or integrated access and backhaul donor gNB.

17. The information transmission method of claim 16, wherein the integrated access and backhaul indication information is sent via an NG SETUP REQUEST, or NG SETUP RESPONSE, or RAN CONFIGURATION UPDATE, or RAN CONFIGURATION UPDATE ACKNOWLEDGE, or AMF CONFIGURATION UPDATE, or AMF CONFIGURATION UPDATE ACKNOWLEDGE.

18. The information transmission method of claim 2, wherein the base station is an integrated access and backhaul donor central unit (CU) or integrated access and backhaul donor gNB.

19. A wireless communication device comprising a processor configured to implement a method comprising:
transmitting integrated access and backhaul indication information, the integrated access and backhaul indication information comprising mobile integrated access and backhaul node information, the integrated access and backhaul indication information being usable when a mobile integrated access and backhaul node has one or more User Equipment (UE) connected to it.

20. A computer program product comprising a computer-readable medium having code stored thereon, the code, when executed, causing a processor to implement a method comprising:
transmitting integrated access and backhaul indication information, the integrated access and backhaul indication information comprising mobile integrated access and backhaul node information, the integrated access and backhaul indication information being usable when a mobile integrated access and backhaul node has one or more User Equipment (UE) connected to it.
